(19) United States
(12) Patent Application Publication
(10) Pub. No.: US 2025/0383066 A1
(43) Pub. Date: Dec. 18, 2025

(54) Optical Display Device

(71) Applicant: InnerScene Limited, Gloucester (GB)

(72) Inventor: Sean Flynn, Gloucester (GB)

(73) Assignee: InnerScene Limited, Gloucester, GL (GB)

(21) Appl. No.: 18/877,250

(22) PCT Filed: Jun. 23, 2023
(86) PCT No.: PCT/GB2023/051648

§ 371 Date: Dec. 19, 2024

(30) Foreign Application Priority Data
Jun. 24, 2022 (GB) 2209337.1

(51) Int. Cl. F21V 13/04; F21V 5/02; F21V 7/06; F21V 9/02

(52) U.S. Cl. CPC F21V 13/04; F21V 5/02; F21V 7/06; F21V 9/02

(57) ABSTRACT

An optical display device arranged to create a perception of a sky scene, comprising: a collimated light generation system comprising: a collimated light source to produce a collimated light beam; a first optical expansion system; a second optical expansion system; a diffuse light generation system, and; an output aperture through which output light is projected, the diffuse light generation system arranged to generate a diffuse skylight component in the output light, and the collimated light generation system arranged to generate a collimated sunlight component in the output light, wherein the first optical expansion system is arranged to expand the collimated light beam in a first expanded direction over the output aperture as the collimated sunlight component, and the second optical expansion system is arranged to expand the collimated light beam in a second expanded direction over the output aperture as the collimated sunlight component.

### TECHNICAL FIELD

The present disclosure relates generally to electrically operated optical display devices for creating an artificial skylight, wherein an observer experiences a perception of a sky scene when gazing into an output aperture of said device.

### BACKGROUND

A device that creates a perception of a skylight is provided in EP3181999 A. Said device generates a collimated beam of light from a light source and collimating lens array. The collimated light beam is transmitted directly to (e.g. without folding of the light beam via a reflective member) and through a partially transparent diffuse light generator. A portion of the collimated beam is scattered by the diffuse light generator by Rayleigh scattering as blue, diffuse light to provide an artificial skylight component and a portion of the collimated beam passes through the diffuse light generator to provide an artificial sunlight component.

Such devices are expensive and complex to construct since they require large arrays of light sources to achieve an intensity representative of sunlight and precise alignment of the light sources and individual collimating lens array is required. Moreover, such devices may be complicated to achieve a representative depth perception.

Therefore, in spite of the effort already invested in the development of said devices further improvements are desirable.

### SUMMARY

The present disclosure provides an optical display device arranged to create a perception of a sky scene in output light. The optical display device comprises: a collimated light generation system; a diffuse light generating system, and; an output aperture through which the output light is projected. The diffuse light generation system is arranged to generate a diffuse skylight (e.g., blue, purple, orange or other colour of the sky) component in the output light. The collimated light generation system is arranged to generate a collimated sunlight (e.g., white and/or yellow) component in the output light, which maybe observed as a sun like disc projected at infinity. In embodiments, the collimated light generation system comprises one or more of a collimated light source that may comprise a light source and a collimating system/member arranged to collimate light as a collimated light beam from the light source.

### [Beam Expansion]

In embodiments, the collimated light generation system comprises a first optical expansion system, and; a second optical expansion system. The first optical expansion system is arranged to expand the collimated light beam in a first expanded direction over the output aperture as the collimated sunlight component, and the second optical expansion system is arranged to expand the collimated light beam in a second expanded direction over the output aperture as the collimated sunlight component. In embodiments, the second expanded direction is different (e.g., not collinear) to the first expanded direction.

By implementing a first optical expansion system to expand the collimated light beam (e.g. the beam after the collimating system) in a first direction when viewed at the output aperture, and a second optical expansion system to expand the collimated beam in a second direction, which is different to the first direction, when viewed at the output aperture, a single collimated light source can be expanded, whilst maintaining collimation, at the output aperture. This may obviate multiple collimated light sources to cover separate sections of the output aperture.

As used herein the term “expanded over the output aperture” may refer to the expansion of the collimated light beam by various means upstream of the output aperture, which is has a net effect of expanding the collimated beam in a particular direction (e.g. perpendicular to the direction of beam propagation) so that when the beam is incident on the output aperture, it covers a greater area on the output aperture. The expanded direction may therefore be defined as the expanded length covered over the output aperture.

In embodiments, the first optical expansion system is separate from the second optical expansion system. In embodiments, the second optical expansion system is arranged to expand the light subsequent (e.g., downstream and separate to) to the first optical expansion system. By expanding the collimated light beam first in one direction and subsequently and not simultaneously in another direction, controlled and precise expansion may be achieved.

In embodiments the first optical expansion system is arranged to produce a first expanded collimated light beam from the collimated light beam, and the second optical expansion system is arranged to produce a second expanded collimated light beam from the first expanded collimated light beam.

In embodiments, and the first optical expansion system does not expand (including does not substantially expand) the collimated light beam in the second direction and/or the second optical expansion system does not expand (including does not substantially expand) the collimated light beam in the first expanded direction.

In embodiments, the first and second optical expansion systems are arranged for uniform (e.g., even, including substantially even, expansion) and/or linear expansion (e.g., along a line only, rather than in other direction in the respective expansion direction) of the collimated light in the associated first and second expanded directions. By implementing linear, uniform expansion, the sunlight component of the output light may be uniform, and therefore may more realistically represent sunlight.

As used herein the term “uniform” may refer to even properties of the light, e.g., in terms of one or more of: colour; intensity; collimation; power; other relevant property that is perceived by an observer.

In embodiments, an average angle of divergence of the expanded collimated light beam (e.g., from one or both of the beam expansion systems) is within 10% or 5% or 2.5% of an angle of divergence of the collimated light beam. With such an implementation, the optical expansion systems may maintain suitably collimated light, whilst expanding the beam.

In embodiments, the first and/or second optical expansion systems are configured to expand the collimated light beam in the respective first and second directions by at least a multiple of 2 or 3 or 5 or 10 times with an optional maximum of 20 or 30 times. With such an implementation a single collimated light beam may be expanded to cover a large portion of the output aperture.

In embodiments, the collimated light beam is expanded in at least one of said directions to the extent (including substantially to the extent) of the output aperture in said direction. With such an arrangement a single light source may cover all the output aperture in at least one direction, which may obviate the need for numerous light sources.

In embodiments, the first and second expansion direction are orthogonal to each other/over the output aperture. In embodiments, the output aperture extends in a longitudinal and lateral direction, wherein the first direction is aligned to the lateral direction and the second direction is aligned to the longitudinal direction. With such an arrangement two optical expansion systems may be used to cover the whole output aperture.

In embodiments, the first optical expansion system comprises: a prism sheet arranged inclined to a direction of propagation of the incident collimated light beam, and to expand the collimated light beam to the first expanded collimated light beam. By arranging the collimated light beam to project inclined to the first prism sheet, the beam is incident over a larger length of the prism sheet than a width of the beam, hence by selecting a particular incline angle (e.g., 2-30 or 5-20 degrees) a large degree of expansion may be achieved. The prism sheet may expand the beam by reflection or reflection and refraction.

In embodiments, the prism sheet is arranged for transmission of the collimated light beam therethrough or to reflect therefrom. In embodiments the prism sheet is arranged inclined to the inclined aperture.

In embodiments, the second optical expansion system comprises: a second prism sheet arranged inclined to a direction of propagation of the incident first expanded collimated light beam, and to expand the first collimated light beam to a second expanded collimated light beam. In embodiments, the first prism sheet is inclined to the second prism sheet. By arranging the collimated light beam to project inclined to the second prism sheet, the beam is incident over a larger length of the prism sheet than a width of the beam, hence by selecting a particular incline angle (e.g. 3-30 or 5-20 degrees) a large degree of expansion may be achieved. The prism sheet may expand the beam by reflection or reflection and refraction.

In embodiments, the second prism sheet is arranged over, and may be planar to, the output aperture and to project the second expanded collimated light beam through the output aperture as the collimated sunlight component. By arranging the second prism sheet to overlap the output aperture (e.g. when viewed in a direction perpendicular to the plane of the output aperture), and preferably to be aligned in the same plane as the output aperture, the device may be compact and/or convenient to assemble.

In embodiments, the collimated light source comprises a light source and a collimating system to receive light from the light source and produce the collimated light beam therefrom, wherein the collimation system is an off-axis parabolic reflector. An off-axis parabolic reflector may provide a cost-effective collimating system.

In embodiments, the light source projects to the collimating system via a coupling system. The coupling system may provide a convenient expansion of the light beam from the light source before being collimated by the collimating system. The coupling system may comprise one or more of a: prism; a light pipe; a lens (e.g., a convex lens).

In embodiments, the collimated light source (including one or more of: the light source; the coupling system the collimating system) is arranged not to interfere (e.g., by means of a viewing angle dependent member and/or a positional arrangement) with light projected from the collimating system and an the/or the first prism sheet.

### [View Control]

In embodiments, a viewing control system is arranged to obscure at least part of the collimated light generation system and/or the diffuse light generation system when viewed through the output aperture.

By arranging the viewing control system to fully or partially reduce visibility (relative to a condition of viewing control system being omitted) of the collimated light generation system (e.g. one or more of the light source, the collimating system and mounting componentry for said components) and/or the diffuse light generation system (e.g. the light source and/or the diffuser), a more realistic appearance of the sky scene may be provided which is absent visual cues to the contrary.

In embodiments, the viewing control system at least partially overlaps the output aperture. By arranging the viewing control system to overlap the output aperture (e.g. the output aperture is aligned to a plane defined by the lateral and longitudinal directions, and overlap is observed with viewing along a normal to said plane), the viewing control system may conveniently obscure said componentry.

In embodiments, viewing control system comprises a viewing angle dependent member, which is configured to be optically transparent (including substantially optically transparent) from a first viewing angle range, and is at optically opaque (including substantially optically opaque) from a second different viewing angle range.

By implementing a member with variable opacity (said opacity may include blurring) based on viewing angle, said member can be arranged to prevent/reduce visibility of the aforementioned components of the device (e.g., one or more of the: light source; collimating members, and; a prism sheet) at particular viewing angles, e.g. at high angles of incidence (e.g. greater than 60 or 70 or 80 or 85 degrees) to the output aperture said member may be opaque.

In embodiments, the viewing control system comprises a reflector system, which is arranged to reflect light from the light source (e.g., collimated light and/or pre-collimated light) around the light source and/or the collimating system and/or the prism sheet of the first optical expansion system.

By implement the reflector system to reflecting the light around the collimated light source/prism sheet (e.g., so that the reflected light overlaps the collimated light source/prism sheet when viewed from a plane defined by the lateral and longitudinal directions) a visibility of the collimated light source/prism sheet from the output aperture may be reduced.

In embodiments, the reflector system comprises one or more reflective members arranged to reflect collimated light from the collimating system in an opposed direction (including a substantially opposed direction) and at a different depth (including at a substantially different depth). By implementing the reflector system to reflect the collimated light back across the collimated light source in an opposed longitudinal direction to projection and at a depth so that it is between the collimated light source and the output aperture a visibility of the collimated light source from the output aperture may be reduced.

In embodiments, the reflector system comprises a shelf member arranged in a line of sight between the output aperture and the collimated light source (e.g. the light source and/or the or the collimating system) from being visible from predetermined viewing angles.

In embodiments, the shelf member is arranged with an exterior surface that is diffusely reflective and may be is white. In embodiments, the shelf member is arranged to prevent the collimated light source from being visible from predetermined viewing angle. In embodiments, the light source is arranged not to overlap the output aperture.

### [Beam Supposition]

In embodiments, the collimated light generation system comprises: a first collimated light source, and; a second collimated light source, wherein the collimated light generation system is arranged with first and second collimated light beams that are projected from the respective first collimated light source and the second collimated light source through the output aperture.

In embodiments, the first and second collimated light beams are superimposed on each other. In embodiments, the first and second collimated light beams are superimposed on each other with a common central axis (including substantially common). A superimposed collimated light beam is projected through the output aperture as the collimated sunlight component.

By implementing first and second collimated light sources, which each project collimated light beams that are superimposed on each other such that they share the same common central axis, an intensity of both beams can be superimposed to create a greater intensity beam than would be achieved for a single light source, which may be more representative of sunlight. Moreover, a colour component of the superimposed collimated beam can be conveniently controlled by varying the proportion of the light from each collimated light source, e.g. to provide a more yellow or white sunlight component.

As used herein the term “central axis” may refer to an axis about which a centre point of a beam of collimated light is projected from one of the collimated light sources. As used herein the term “common” in respect of the central axes may refer to the axes being exactly aligned, or sufficiently aligned, e.g. to provide the appearance of a single beam of sunlight of uniform intensity over the beam projection area.

In embodiments, the first collimated light source comprises a light source and a collimating system and the second collimated light source may comprise a light source and a collimating system. Alternatively, the first collimated light source and second collimated light source may comprise separate beams derived from a common single light source and/or collimating systems.

In embodiments, the first and second light beams are uniform (including substantially uniform). By implementing the first and second light beam to be uniform (e.g., over the output aperture) precise alignment of there central axis may be obviated. In embodiments, the first and second light beams and are fully superimposed onto each other, e.g. so at least one is fully overlapped by the other, and both may fully overlap each other at the output aperture.

In embodiments, the collimated light generation system includes a mixing element, which is arranged to superimpose the light beams from the first collimated light source and the second collimated light source. The mixing element may be arranged to superimpose the light beams from the first collimated light source and the second collimated light source with said common central axes. The mixing element may project the collimated sunlight component/superimposed collimated light beam to the output aperture. By implementing a mixing element, such as a prism sheet, the light beams may be conveniently superimposed on top of each other.

In embodiments, the light beam from the first collimated light source and the light beam from the second collimated light source are projected to the mixing element in different directions. The different directions may be opposed in the lateral and/or longitudinal component of said direction. By having the light beams project from different directions to the mixing element they may be conveniently combined.

In embodiments, the light beam from the first collimated light source and the light beam from the second collimated light source are projected to the mixing element with the central axes thereof to (including substantially to) a common intersection point. By arranging the light beams to intersect at a common (including substantially common) central point, which may be located on or in the mixing element, they may be conveniently combined.

In embodiments, a superimposed collimated light beam is projected with a central axis which intersects (including substantially intersects) a centre of the output aperture. As used herein the term “centre” with respect to the output aperture may refer exactly at the centre of the output aperture when considering a plane defined by longitudinal and lateral directions or substantially at the centre e.g., offset by no more than 95% or 90% of longitudinal length or lateral width of the output aperture.

In embodiments, the superimposed collimated light beam covers the entire output aperture. By arranging said beam to project through the entirety of the output aperture, a realistic simulation of the sunlight may be provided. As used herein the term “entire” in respect of the output aperture may refer to full coverage e.g., 100% of the surface area defined in the longitudinal and lateral plane or substantially full coverage, e.g., at least 95%.

In embodiments, the mixing element comprises a prism sheet. In embodiments, the prism sheet is arranged to overlap and may be coplanar the output aperture. By arranging the prism sheet to overlap, e.g., substantially, or fully, in the plane defined by the longitudinal and lateral directions, and be coplanar, including substantially coplanar, to the output aperture, the device may be convenient to assemble and may be compact.

In embodiments, the prism sheet is arranged substantially in the depth direction and lateral direction and may be inclined to the depth direction.

In embodiments, the prism sheet is arranged to reorientate the collimated light beams and project a superimposed collimated light beam to the output aperture.

In embodiments, the prism sheet comprises symmetrical prismatic projections. The prismatic projections may be symmetrical about an axis of symmetry that is perpendicular to the incident direction of first and second collimated light beams.

In embodiments, a light source of the a first collimated light source is independently controllable to a light source of the second collimated light source. By implementing the light sources to be independently controllable, electrical circuitry may control an intensity of either light source to vary a proportion of the collimated sunlight component from either light source. In embodiments, the first collimated light source and second collimated light source have a different colour (e.g., a CCT or other colour model), such that a colour of the collimated sunlight component can be controlled by controlling an intensity of the light sources.

In a similar manner, a light source of the diffuse light generation system may be independently controllable to the first collimated light source and/or the second collimated light source (where the latter is present). Such an arrangement may enable control of a proportion of diffuse skylight component and a proportion of collimated sunlight component in the output light.

[Beams that are not Superimposed]

In embodiments, the collimated light generation system is arranged with the first and second collimated light beams, that are projected from the first collimated light source and the second collimated light source through the output aperture, to bound each other and have laterally aligned and longitudinally and offset central axis.

By implementing the first and second beams to project through the output aperture in a manner that they which bound each other and also so that they have laterally aligned and longitudinally and offset central axis, they may conveniently cover the whole of the output aperture but with individually controllable portions. As used herein the term “bound” in respect of the light beams may refer to the light beams having an edge that is either entirely or substantially (e.g. so that there is minimum overlap or gap between and adjoining edge) aligned.

In embodiments, the collimated light generation system includes a projection element, which is arranged with: a first portion to receive the first collimated light beam and to direct said beam to the output aperture; a second portion to receive the second collimated light beam and to direct said beam to the output aperture (e.g., so that both beams are directed in the same direction to the output aperture). The projection element may be implemented as a prism sheet, with prisms of the first portion differently configured to the section portion to handle the different projection directions of the first and second collimated beam.

In embodiments, the light beam from the first collimated light source and the light beam from the second collimated light source are projected to the projection element in different directions. In embodiments, the projection element is arranged to direct the first and second collimated beams to cover the entire output aperture.

### [Oblique Projection]

In embodiments, the collimated light generating system comprising a reflective member, and the output aperture has a periphery that extends in a first plane defined by a lateral and longitudinal direction, and the reflective member is arranged to project light obliquely across the first plane inclined to both the lateral and longitudinal directions.

By implementing the light to project obliquely, e.g. diagonally, in an overlapping manner over the output aperture (or in a plane that the output aperture resides in), the light path that the light of the collimated light generation system takes may be conveniently folded to maximise the distance, which may improve the visual appearance of the sunlight component at infinity.

In embodiments, the reflective member is positioned to at least partially overlap the output aperture. By arranging the reflective member over the output aperture a small form factor of the device may be achieved. Moreover, it may enable the devices to be arranged side by side without a substantial gap between adjoining output apertures of the devices.

In embodiments, the reflective member is an off-axis parabolic reflector arranged to reflect light as collimated light. Such an arrangement may provide a cost-effective collimation configuration.

In embodiments, the reflective member is inclined to both the first plane and a second plane defined by a depth direction and the longitudinal direction and/or a plane defined by a depth direction and the lateral direction.

In embodiments, pre-collimated light from the light source is projected obliquely across the first plane. By arranging the light source to project light obliquely (e.g. diagonally) over the output aperture (or in a plane that the output aperture resides in), the light path that the light of the collimated light generation system takes may be conveniently folded to maximise the distance, which may improve the visual appearance of the sunlight component at infinity.

In embodiments, a coupling system (e.g., a prism) is arranged to transmit (e.g. directly) pre-collimated light from the light source to the reflective member. In embodiments, the pre-collimated light is projected obliquely across the first plane. By arranging the coupling system to project light obliquely (e.g. diagonally) over the output aperture (or in a plane that the output aperture resides in), the light path that the light of the collimated light generation system takes may be conveniently folded to maximise the distance, which may improve the visual appearance of the sunlight component at infinity.

In embodiments, the coupling system is positioned to at least partially overlap the output aperture. By arranging the coupling system over the output aperture, a small form factor of the device may be achieved.

In embodiments, the light source is positioned to at least partially overlap the output aperture. By arranging the light source over the output aperture, a small form factor of the device may be achieved.

In embodiments, the collimated light generation system comprises a first prism sheet arranged to project reorientated collimated light from the reflective member to the output aperture, wherein the reflective member projects collimated light (e.g. directly) to the first prism sheet. In embodiments, and the first prism sheet is arranged to reorientate the collimated light by reflection and/or refraction. The first prism sheet may be inclined to the depth direction.

In embodiments, the collimated light generation system comprises a second prism sheet arranged to receive the collimated light from (e.g. directly or via a reflective member) the first prism sheet, with the second prism sheet arranged in the first plane. In embodiments, the second prism sheet is arranged to reorientate the collimated light by reflection and/or refraction. In embodiments, the diffuse light generator is arranged in the first plane.

### [Off-Axis Collimator]

In embodiments, the collimated light generating system comprises an off-axis reflective member, wherein the off-axis reflective member is arranged to receive light from the light source and to project collimated light to the output aperture as a sunlight component.

By implementing an off-axis reflective member as the collimating system, the light beam may be conveniently folded and collimated. Folding of the light beam may enable a greater distance between the light source and output aperture, which may increase the perception of the source being at infinity. Folding of the light beam may, for a given distance between the light source and output aperture, enable the arrangement of the optical display device with a smaller form factor.

In embodiments, the off-axis reflective member has a reflective surface an a planar rear surface, wherein said rear surface is arranged with an edge aligned (including substantially aligned with a minor degree, e.g. 0-20 degrees of tilt) to one or more of: a longitudinal direction; a lateral direction, and; a depth direction, of the device.

In embodiments, the off-axis reflective member is arranged with at least one edge parallel (including substantially parallel) to one or more of: a lateral direction; a longitudinal direction; a depth direction. By having at least one edge parallel to said directions, the device may be convenient to assemble.

### [Projection Over Entire Output Aperture]

In embodiments, a collimated light generation system comprising a single light source (which may be the only light source of the collimated light generating system) and a collimating system (which may be the only collimating system of the collimated light generating system), and the output aperture extends rectangularly in a lateral and longitudinal direction and the collimate light generating system is arranged to project the collimated light from the single light source over the entire output aperture.

By implement the collimated light generation system to project a collimated sunlight component to cover the entire output aperture using light which is expanded from a single light source, a cost-effective device may be provided, which may be convenient to assemble. Moreover, the device may have a high level of accuracy since there are no issues with integrating light from difference sources in the collimated sunlight component.

In embodiments, the collimated light generation system is arranged to internally reflect the collimated light beam at least once or twice or three times before it is output as the collimated sunlight component. A maximum number of reflections may be 4 or 5 or 6 times. By internally reflecting the collimated light beam, a light path from the light source to the output aperture is increased which may improve the appearance of the sun at infinity.

In embodiments, the single light source may implement the first optical expansion system and/or the second optical expansion system and all features associated therewith. The single light source and collimated system may be implemented as the first collimated light source (e.g., but without the second collimated light source present) and all features associated therewith.

### [Use/Kit of Parts]

The present disclosure provides a kit of parts for assembly into the optical display device of any preceding embodiment, or another embodiment disclosed herein.

The present disclosure provides use of the device of any preceding embodiment, or another embodiment disclosed herein for creating a perception of a sky scene.

### Method

The present disclosure provides a method of creating a perception of a sky scene.

In embodiments, the method comprises expanding light from a collimated light beam in a first direction when viewed at an output aperture; expanding light from the collimated light beam in a second direction when viewed at the output aperture, and; outputting the expanded collimated light as a collimated sunlight component.

In embodiments, the method comprises obscuring at least part of the collimated light generating system when viewed through the output aperture with a viewing control system. In embodiments, the method comprises obscuring at least part of the diffuse light generating system when viewed through the output aperture with a viewing control system.

In embodiments, the method comprises projecting collimated light beams from a first collimated light source and a second collimated light source about a common central axes as a superimposed collimated light beam and; outputting the superimposed collimated light beam as a collimated sunlight component.

In embodiments, the method comprises projecting collimated light from a single light source over an entire output aperture.

In embodiments, the method comprises projecting collimated light beams from a first collimated light source and second collimated light source through an output aperture, with said beams arranged to bound each other and to have laterally aligned and longitudinally and offset central axis.

In embodiments, the method comprises transmitting a collimated light obliquely over an output aperture, and; outputting the collimated light as a collimated sunlight component through the output aperture.

In embodiments, the method comprises outputting diffuse light as a diffuse skylight component. In embodiments, the method comprises transmitting light to a diffuse light generator to generate the diffuse light.

The method may implement any feature of any preceding embodiment, or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a block system diagram showing an embodiment optical display device.

FIG. 2 is a plan view in plane defined by a longitudinal direction and a lateral direction showing an embodiment of the optical display device of FIG. 1.

FIG. 3 is a side view in a plane defined by the longitudinal direction and a depth direction of the optical display device of FIG. 2.

FIG. 4 is an end view in a plane defined by the lateral direction and a depth direction of the optical display device of FIG. 2.

FIG. 5 is a plan view in plane defined by a longitudinal direction and a lateral direction showing an embodiment of the optical display device of FIG. 1.

FIG. 6 is a side view in a plane defined by the longitudinal direction and a depth direction of the optical display device of FIG. 5.

FIG. 7 is a perspective plan view in plane defined by a longitudinal direction and a lateral direction showing an embodiment of the optical display device of FIG. 1.

FIG. 8 is a side view in a plane defined by the longitudinal direction and a depth direction of the optical display device of FIG. 7.

FIG. 9 is an end view in a plane defined by the lateral direction and a depth direction of the optical display device of FIG. 7.

FIG. 10 is an elevated perspective plan view in plane defined by a longitudinal direction and a lateral direction showing an embodiment of the optical display device of FIG. 1.

### DETAILED DESCRIPTION OF EMBODIMENTS

Before describing several embodiments of the device, it is to be understood that the device is not limited to the details of construction or process steps set forth in the following description. It will be apparent to those skilled in the art having the benefit of the present disclosure that the device is capable of other embodiments and of being practiced or being carried out in various ways.

The present disclosure may be better understood in view of the following explanations:

As used herein the term “optical display device” or “device” may refer to electrically operated optical apparatus that is capable of providing an observer that perception of a sky scene when gazing into an output aperture of the device. The device may be dimensioned such that it is suitable for attachment to a ceiling or wall of an interior or a building, e.g., it is less than 1.5 meters or 2 meters or 3 meters in lateral and/or longitudinal dimension.

As used herein the term “perception of infinite depth” may refer to a depth of an object (e.g. the sky and/or sun) in three dimensions being perceived as infinitely far away from an observer with stereopsis (i.e. binocular vision). A perception of infinite depth may be provided by one or more of the following monocular or binocular visual cues presented to an observer when looking into an output aperture of the device: motion parallax; interposition: aerial perspective; accommodation; stereopsis; convergence, and; other related cues. The condition of infinite depth may be determined based on gaze vectors of the eyes of an observer having the same and/or a similar alignment when looking into the device as for looking at the sky and/or sun in real life. The condition of infinite depth based on motion parallax may be determined based on the image of the sun appearing to be projected from the same location, e.g. moving, as an observer moves laterally and/or longitudinally across the output aperture. An observer user may maintain the same gaze vector associated with infinite depth during said motion.

As used herein the term “perception of a sky scene” may refer an observer perceiving a sky scene as being present in the real world, based on the construction by the device of a virtual sky scene that is sufficiently representative, e.g., in terms of chromatic and spatial distribution of light, to present as in the real world.

As used herein the term “sky scene” may refer to a scene comprising a sky that an observer observes when gazing through a window (e.g., in a side wall or ceiling) of a structure. A sky scene may include a skylight component and a sunlight component as defined herein. It may include a circular (including substantially circular) sun coloured image of the sunlight component, which is surrounded by a blue sky (or other colour representative of the sky) of the skylight component.

As used herein the term “skylight” or “skylight component” or “diffuse light component” may refer to artificial light that is representative of skylight (e.g., absent a direct sunlight component), which can include daylight, sunset or sunrise. It may be representative of skylight in respect of one or more of: colour, e.g., as defined by a CCT (e.g., 5000-10000); diffusivity; luminance profile or intensity; other suitable parameter, and; a variance of any of the aforesaid over an output aperture of the device. The diffuse light component may be uniform such that is does not vary by more than 10% or 20% or 30% or 40% over the entire output aperture, e.g., in terms of one or more of: colour diffusivity; luminance profile; intensity, and other suitable parameter. More particularly, said one or more parameters may be uniform to the extent where they do not vary by more than 10% or 20% or 30% or 40% for any given circular area on the output aperture of 10 mm diameter over at least 90% of the output aperture. In a particular example, the diffuse light is propagated over a HWHM solid angle that is at least 4 times larger or 9 times larger or 16 times larger than for the subtending HWHM solid angle of the sunlight measured in Sr.

As used herein the term “sunlight” or “sunlight component” or “direct light component” may refer to artificial light that is representative of sunlight. It may be representative of sunlight in respect of one or more of: colour, e.g. as defined by a CCT (e.g. 3000-5000 k, which is less than that of the skylight component); divergence (e.g. an angle of divergence of the light rays may be no more than 5 or 2 or 1 or 0.5 degrees); luminance profile or intensity; other suitable parameter, and; a variance of any of the aforesaid over an output aperture of the device. In a particular example, the luminance profile of the sunlight may have a narrow peak in the angular distribution around the direction of propagation which is subtended by a HWHM solid angle smaller than 0.2 sr or 0.3 sr. The sunlight component may be projected uniformly over the output aperture, e.g., such that an average direction of propagation within a circle of diameter 10 mm at any position over the output aperture does not vary by more than 2 or 5 or 10%. The sunlight may present, to a user when looking into the device, as a circular disc positioned at infinity.

As used herein the term “collimated light” may refer to light that has been processed by a collimated light generation system, which may form the sunlight component.

As used herein the term “output aperture” may refer to a viewing window of the device into which an observer can gaze. The output aperture may be 0.5-2 m×0.5-2 m. The output aperture outputs output light which is generated by the device. The output aperture may be defined by a transparent panel, that can include glass or plastic or no such member, it may for example comprise a void instead of such a member.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “diffuse light generator” or diffuse light generation system” may refer to a single (e.g. a collimating member) or a distributed system capable of generating a diffuse light component, e.g. light which is scattered in many angles as opposed to one angle as with specular reflection. The diffuse light generator may generate the diffuse light by reflecting incident light as diffuse light or may be at least partially transparent and generate diffuse light in the light transmitted therethrough, e.g. by particles suspended in a transparent material. The diffuse light generator may be implemented as one or more of the following: particles to scatter light; conical micro cones; micro lenses; quantum dots; surface features, including surface etching, and; other suitable implementation.

As used herein the term “scattering light” may refer to a process performed on incident light by the diffuse light generator to generate diffuse light, any may include Rayleigh scattering.

As used herein the term “particles to scatter said light” may refer to particles with a diameter selected to scatter some or all wavelengths of visible light. The diameter of the particles may be micro or nano (e.g. to operate in the Rayleigh regime). The diffuse light generator can include said particles arranged in a medium. Examples include titanium dioxide suspended in PMMA.

As used herein the term “light guide panel” may refer to a generally planar member, which is arranged to convey light in the in-plane direction, e.g., by total internal reflection, as a waveguide. The light guide panel may be edge lit, e.g., by a light source. The light guide panel may be implemented as the diffuse light generator, e.g., particles in the light guide panel scatter the light to enable it to exit the waveguide.

As used herein the term “light source” may refer to any arrangement capable of generating artificial light. It can include arrangements that transform electrical current into luminous radiation. The light may have wavelengths in the range of 400-700 nm. The light source can include one or more of the following: a white light source, or perceived as such by the eye, e.g. an incandescent lamp, a fluorescent lamp, a mercury vapor discharge lamp; an LED or a white light laser diode (that is, such that the primary source is combined with a phosphor or several phosphors) or a combination of LEDs or laser diodes of different colour, and; other suitable light source. The light source may include a light guide to receive light from an emitting portion and convey the light, e.g., by total internal reflection, to an output surface. The light source may be arranged to emit with a CCT of 3K to 20K, or over a daylight locus. The luminance profile may not vary by more than 20% over any circular area of 10 mm diameter.

As used herein the term “chromatic system” may refer to an arrangement capable of imparting a particular colour to light, e.g., from the light source. The colour may be representative of sky scene, including daylight, sunset or sunrise. It may for example include a filter. The chromatic system may be applied to the skylight or sunlight component.

As used herein the term “collimated light generation system” may refer to a single or a distributed (e.g., more than one) collimated light source for producing a collimated beam. It may include a collimating members/system, which may be implemented as one or more of the following: a lens, including a Fresnel lens; a parabolic reflector; a closed cell structure, through the cells of which light is projected, and; other suitable system. The collimated light generation system may include a light source (e.g., a dedicated or general light source for the collimated light) for outputting light to be collimated by the collimating member. The collimating member may be omitted where the light source is a laser or other source with a suitably collimated output. The collimating system may consist of only one single collimating member and optional single light source.

As used herein, the term “prism sheet” may refer to an arrangement of prisms on a planar member, which maintain an initial degree of collimation of an incident light beam, but which expands said beam. The expansion may be achieved by reflection or reflection and/or refraction. An example of such an arrangement is disclosed in WO2017048569A.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the device, or distributed between one or more of: the device; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g., which may take the form of machine-readable instructions, which may be stored on a non-transitory memory and/or programmable logic. The processor may have various arrangements corresponding to those discussed for the circuitry. As used herein, any machine executable instructions, or computer readable media, may be configured to cause a disclosed method to be carried out, e.g., by the device or system as disclosed herein, and may therefore be used synonymously with the term method, or each other.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g., the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The device may include communication resources for wired or wireless communication with an external device and/or server system.

As used herein, the term “external device” or “external electronic device” or “peripheral device” may include electronic components external to the device, e.g. those arranged at a same location as the machine or those remote from the device, which communicate with the device over a computer network. The external device may comprise a communication interface for communication with the machine and/or a server system. The external device may comprise devices including: a smartphone; a PDA; a video game controller; a tablet; a laptop; or other like device.

### General System

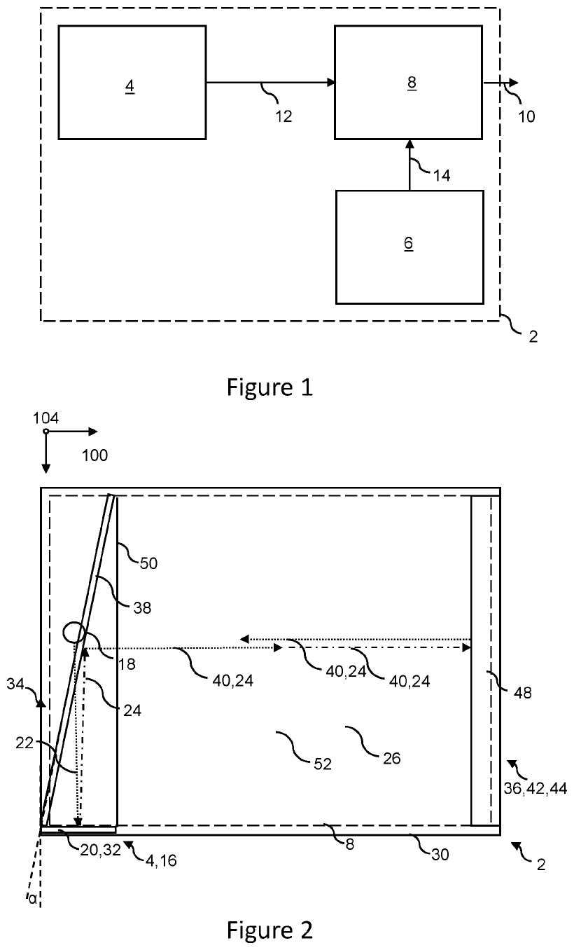

Referring to FIG. 1, a device 2 to create a perception of a sky scene in output light comprises a collimated light generation system 4, a diffuse light generation system 6, and; an output aperture 8 through which output light 10 is projected. The collimated light generation system 4 generates a collimated sunlight component 12 in the output light 10. The diffuse light generation system 6 generates a diffuse skylight component 14 in the output light 10.

In variant embodiments, which are not illustrated: the diffuse light generation system is omitted, e.g., so that the sky scene comprises only sunlight.

### First Example

Referring to FIGS. 2, 3 and 4, a first example of the device 2 comprises the collimated light generation system 4 with a first collimated light source 16. The first collimated light source 16 comprises a light source 18 and a collimating system 20. The light source 18 projects a light beam 22 to the collimating system 20, which processes the received light to output a collimated light beam 24, which forms the collimated sunlight component 12 in the output light 10.

In variant embodiments, which are not illustrated: the collimated light generation system includes more than one collimated light source and/or collimating system.

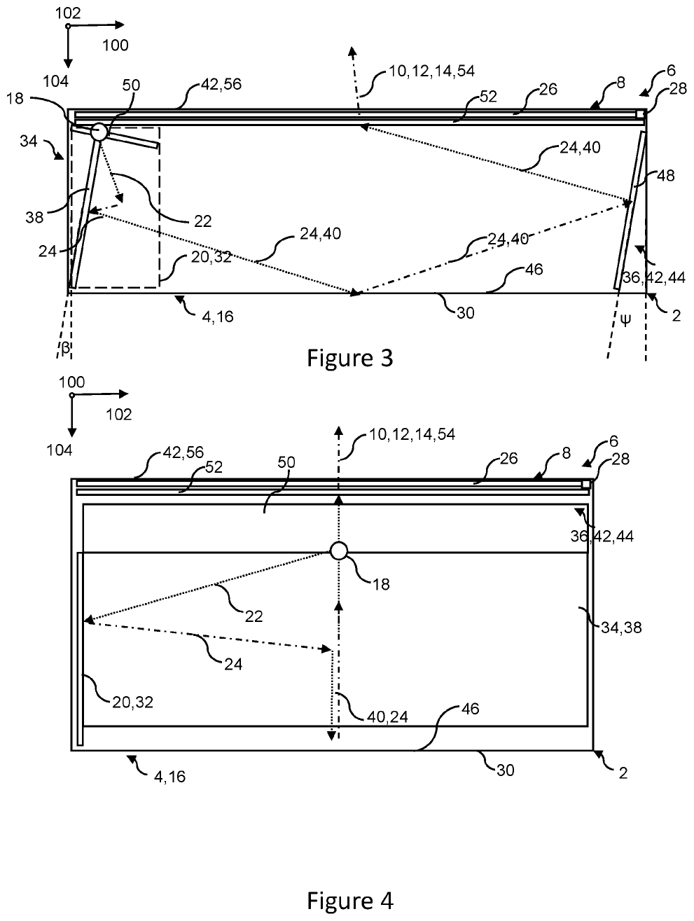

As best seen in FIGS. 3 and 4, the diffuse light generation system 6 includes a diffuser 26 arranged as a waveguide through which the collimated sunlight component 12 is projected. The diffuse light generation system 6 includes a dedicated diffuse light source 28, which emits light into an edge of the diffuser 26. The diffuser 26 includes particles (not illustrated) which scatter the internally reflected light from the light source 28. The light emitted from the light source 28 is retained within the diffuser 26 by total internal reflection until it encounters a particle and is scattered enabling it to exit the diffuser 26 as the diffuse skylight component 14. A portion of the collimated sunlight component 12 that encounters a particle may also be scattered in this manner.

In variant embodiments, which are not illustrated, the diffuse light generation system may omit said dedicated diffuse light source, with the diffuse skylight component being provided by the portion of the collimated light that is scattered by the transparent member; the diffuser may be alternatively arranged e.g. it may form the output aperture; other diffuse light generation systems are also to be contemplated.

The output aperture 8 is planar and is aligned in a longitudinal direction 100 and lateral direction 102. A thickness of the device 2 is arranged in a depth direction 104. A housing 30 containing the herein described components of the device 2 extends in the longitudinal direction 100, lateral direction 102 and the depth direction 104.

The collimating system 20 of the collimated light generating system 4 comprises an off-axis parabolic reflector 32, which receives the light beam 22 from the light source 18 to produce the collimated light beam 24.

The light beam 22 is transmitted to the off-axis parabolic reflector 32 by means of a coupling system (not illustrated). The coupling system expands the light beam 22 such that it is projected over (including substantially over) full extent of the off-axis parabolic reflector 32. The coupling system comprises a light pipe (which can be straight or tapered to expand the light) to receive light from the light source 18 at a first end and provide the light beam 22 at a second end.

In variant embodiments, which are not illustrated, the coupling system is alternatively arranged and comprises: a prism arranged to receive light from the light source and to refract the light to provide the light beam, and; other suitable arrangements including combinations of those disclosed.

The off-axis parabolic reflector 32 comprises a curved reflector surface which is generally arranged on a support with a planar rear surface. The planar rear surface of the parabolic reflector 32 is arranged aligned in a longitudinal plane defined by the longitudinal direction 100 and the depth direction 104. In particular, it is arranged on an interior of a side panel of the housing 30. Such an arrangement may be convenient to assemble.

An off-axis parabolic reflector enables folding of the light beam 22 (via reflection) and combined collimating. Folding of the light beam 22 in this manner increases a distance that the collimated sunlight component 12 is projected through from between the light source 18 and output aperture 8, which may increase a perception of the sun being at infinity.

In variant embodiments, which are not illustrated: the off-axis parabolic reflector is tilted in one or more of the: longitudinal plane about the depth or longitudinal axes; a lateral plane defined by the lateral direction 102 and the depth direction 104 about the lateral axes. Said tilting may be provided by an adjustable mount, which enables fine tuning of an orientation of the reflector surface. The tilting may be less than 5 or 10 degrees.

In variant embodiments, which are not illustrated, the collimating system is alternatively arranged, including one or more of: it additionally includes a first collimator (e.g. a lens) upstream or downstream of the coupling system; it is arranged as one or more collimating lenses instead of or in addition to the off-axis parabolic reflector.

The collimated light generation system 4 comprises a first optical expansion system 34, and; a second optical expansion system 36. The first optical expansion system 34 is arranged to expand the collimated light beam 24 in a first expanded direction, which in the example is the lateral direction 102, over the output aperture 8 as the collimated sunlight component 12. The second optical expansion system is arranged to further expand the collimated light beam 24 in a second expanded direction, which in the example is the longitudinal direction 100, over the output aperture 8 as the collimated sunlight component 12. The optical expansion systems 32, 34 are arranged to expand the collimated beam 24 whilst maintaining the generally the same degree of collimation that is applied by the collimating system 20. The first optical expansion system 34 is separate from and is upstream to the second optical expansion system 36.

In variant emblement, which are not illustrated: the first optical expansion system is integrated with the second optical expansion system, e.g. by means of an integrated prism sheet.

The first optical expansion system 34 comprises a first prism sheet 38. As best seen in FIG. 2, a plane of the first prism sheet 38, which the associated prisms are aligned on, is inclined at angle α to the direction of propagation of the incoming collimated light beam 24 from the collimating system 20. The incline is substantially to the lateral plane (which is defined by the lateral direction 102 and depth direction 104) and about the depth axis 104. The angle of inclination may be 5-30 degrees. Said incline is such that the collimated light beam 24 is projected across substantially all of the first prism sheet 34. The prisms of the first prism sheet 38 individually reflect and/or refract the collimated light beam 24 over the length of the first prism sheet 38. The first prism sheet 38 is configured to project a first expanded collimated light beam 40 substantially in the longitudinal direction 100. The first expanded collimated light beam 40 is therefore expanded to the lateral component of the length of the first prism sheet 38, which is arranged substantially as the lateral dimension of the output aperture 8.

It will be understood that with such an arrangement, the first prism sheet 38 can expand the incident collimated light beam 24 (in a direction normal the direction of propagation) by greater than 2, 3 or 5 times. A maximum expansion of 10 or 20 or 30 may be determined by the power of the light source and the resolution of the individual prisms.

Referring to FIG. 3, the first prism sheet 38 is additionally inclined at angle β to the lateral plane and about the lateral axis 102. The angle of inclination may be 5-30 degrees. This enables the first expanded collimated light beam 40 to be projected to an optional view control system 42, which comprises a reflector system 44, as will be discussed.

The light source 18 and optional coupling system are arranged not to interfere with the light projected from the first prism sheet 38 and/or the off-axis parabolic reflector 32.

Referring to FIG. 2, the light source 18 and optional coupling system are arranged in the longitudinal direction 100 behind a reflecting surface of the first prism sheet 38. Referring to FIGS. 3 and 4, the light source 18 and optional coupling system are arranged in the depth direction 104 above the off-axis parabolic reflector 32 and first prism sheet 38 between said components and the output aperture 8.

In variant embodiments, which are not illustrated, it will be understood that the light source 18 and optional coupling system may be otherwise arranged not to interfere with the light projected from the first prism sheet 38 and/or the off-axis parabolic reflector, e.g., below the off-axis parabolic reflector 32 and first prism sheet 38 or with other suitable arrangement.

The view control system 42 is arranged to obscure at least part of the collimated light generation system 4 and/or the diffuse light generation system 6, when viewed through the output aperture 8.

The reflector system 44 is configured to conceal the collimating system 20, light source 18 and first prism sheet 38 from an observer when looking through the output aperture 8. The reflector system 44 additionally increases a distance that the collimated sunlight component 12 is projected through from between the light source 18 and output aperture 8, which may increase a perception of the sun being at infinity.

The reflector system 44 comprises a first reflective member 46 (e.g. a mirror) for specular reflection of the first expanded collimated light beam 40. The first reflective member 46 is aligned in the plane of the output aperture 8, at an opposed end of the device to the output aperture 8. The first reflective member 46 reflects the first expanded collimated light beam 40 to a second reflective member 48.

The reflector system 44 comprises the subsequent second reflective member 48 (e.g. a mirror) for specular reflection of the first expanded collimated light beam 40. The second reflective member 48 is arranged substantially on the lateral plane at an opposed end of the device to the first prism sheet 38. The second reflective member 48 is inclined to the lateral plane about the lateral axis 102 by an angle ψ. The angle of inclination may be 5-30 degrees.

The second reflective member 48 reflects the first expanded collimated light beam 40 to and forms part of the second optical expansion system 36, as will be discussed.

The reflector system 44 comprises a shelf member 50, which is aligned parallel to the first expanded collimated light beam 40 that is reflected from the second reflective member 48. The shelf member 50 has an exterior surface that is diffusely reflective and is white. The shelf member 50 prevents/reduces visibility (e.g. from certain viewing angles) of the: collimating system 20; light source 18, and first prism sheet 38, from an observer when looking through the output aperture 8.

In variant embodiments, which are not illustrated: the shelf member is alternatively aligned, e.g. it is arranged inclined to the direction of the proximal collimated light beam, such that the collimated light beam causes shadow over the shelf member; it may be formed of other surface finishes, e.g. a for specular reflection; it may be arranged to conceal the collimating system, light source e.g. and not the first prism sheet; the first reflective member is inclined to the output aperture; the second relative member is aligned to the lateral plane, and may comprise a Fresnel arrangement to give the equivalent of the above described inclined specular reflection; the shelf member may be omitted.

The second optical expansion system 36 comprises a second prism sheet 52. A plane of the second prism sheet 52, which the associated prisms are aligned on, is aligned to the output aperture 8.

As discussed, the second reflective member 48 is inclined such that the first expanded collimated light beam 40 is projected across substantially all of the second prism sheet 52. The prisms of the second prism sheet 52 individually refract and/or reflect the first expanded collimated light beam 40 over the length of the second prism sheet 52 and are transmissive such that the light is transmitted therethough as the second expanded collimated light beam 54. The second prism sheet 52 is configured to project the second expanded collimated light beam 54 in the generally in the depth direction 104 (e.g. at an angle of 0-40 degrees thereto). The second expanded collimated light beam 54 is therefore expanded to the longitudinal component of the length of the second prism sheet 52, which is the longitudinal dimension of the output aperture 8.

The second expanded collimated light beam 54 is transmitted through the diffuser 26 as discussed above. The second expanded collimated light beam 54 projects through the output aperture 8 as the collimated sunlight component 12.

In variant embodiments, the second prism sheet is alternatively arranged: including angled to the output aperture; it only extends partially over the output aperture; one or both prism sheets are replaced by similar function optical devices, e.g. a single prism.

The view control system 42 further comprises a viewing angle dependent member 56, which is configured to be optically transparent from a first viewing angle range, and is at least partially optically opaque from a second different viewing angle range. An example of a suitable material is a Lumisty Vision Control Film, model W-0055, provided by Lumisty products. Said example transitions from clear to frosty at an incidence of greater that 55 degrees. The viewing angle dependent member 56 is arranged in the plane of and to overlap entirely over the output aperture 8. It is down stream of the diffuser 26 and second prism sheet 52.

In variant embodiments, which are not illustrated: the viewing angle dependent member may be omitted; the viewing angle dependent member is alternatively arranged including only to overlap certain parts of the output aperture e.g. where the collimated light source is visible or is arranged upstream of the diffuser.

### Second to Fourth Examples

In variant embodiments, which are not illustrated, various structural modifications of the first example may be implemented, which are all compatible, where relevant with the other examples:

In a second example, the second beam expansion system is omitted, such that the first prism sheet projects light to the output aperture. In such a variant the first prism sheet may be reflective as in the first example or transmissive such that light to the output aperture is transmitted via reflection from or through the second prism sheet respectively.

In a third example, the second prism sheet is alternatively reflective such that it reflects light to an output aperture, with the output aperture located at another other end of the device in the depth direction (rather than being transmissive as in the first example). With such an arrangement the first reflective member may be omitted such that the first prism sheet transmits light directly to the second reflective member, which transmits light to the second prism sheet, or alternatively the first prism sheet may transmit light directly to the second prism sheet (hence the reflector system may be omitted).

In a fourth example, the reflector system is omitted and the first prism sheet transmits light directly to the second prism sheet, in such an example the second prism sheet may be transmissive such that light to the output aperture is transmitted through the second prism sheet.

### Fifth Example

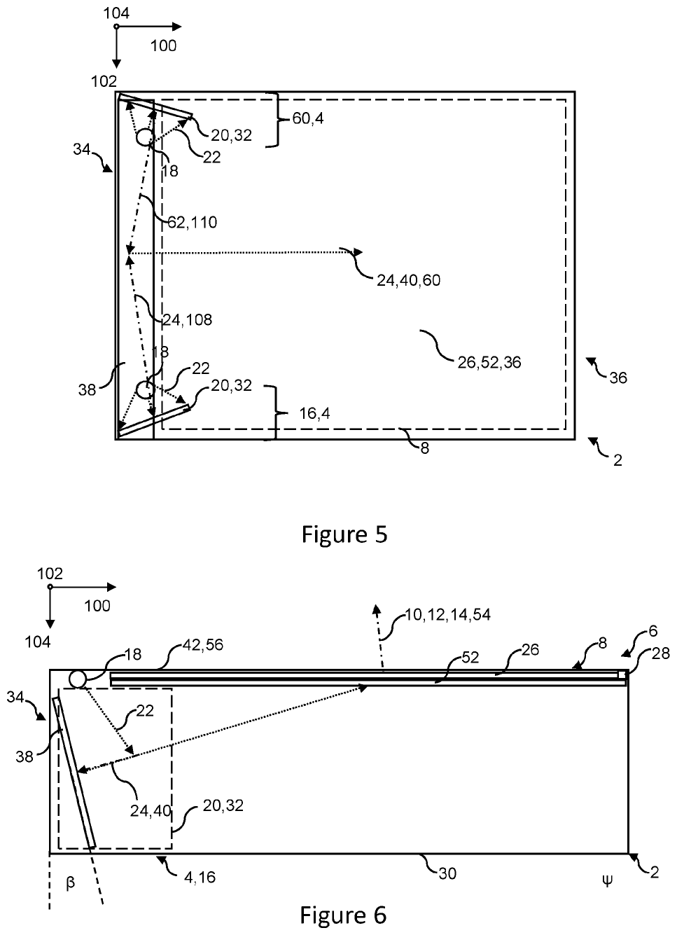

Referring to FIGS. 5 and 6, in a fifth example of the device 2, there are two collimated light sources, which are both expanded by shared beam expansion systems, as will be discussed. The fifth example shares all compatible features and variants in common with the first example, which for brevity are not reiterated. Where compatible, the second to fourth examples may also implement the two collimated light sources as for the fifth example.

In the fifth example, the collimated light generation system 4 comprises: the first collimated light source 16, and; a second collimated light source 60. The collimated light generation system 4 is arranged with the first collimated light beam 24 and a second collimated light beam 62 both projected through the output aperture 8.

The first collimated light beam 24 and the second collimated light beam 62 are superimposed on each other such that they have common central axes 108,110. A superimposed collimated light beam 64 is projected through the output aperture 8 as the collimated sunlight component 12.

In variant embodiments, which are not illustrated: the collimated light beams are superimposed on each other without alignment of their central axes, e.g. said axis may be longitudinally aligned and laterally offset, or the converse etc.

The first collimated light source 16 comprises a dedicated light source 18 and a collimating system 20. The second collimated light source 60 comprises a dedicated light source 18 and a collimating system 20.

With two separate light sources, each light beam of the first and second collimated light sources may be independently controllable with electrical circuitry. In a first variant, the first and second light beam may be configured to project with a different colour beam (which can be achieved by a chromatic system) such that the collimated sunlight component can be controlled in colour (e.g., in CCT) and/or intensity by controlling an intensity of the light sources. In a second variant, the first and second light beam may be configured to project with the same colour beam (including substantially the same colour) such that the collimated sunlight component can be controlled in intensity by controlling an intensity of either collimated light source, e.g., for a low energy mode one of the collimated light sources may be off.

In variant embodiments, which are not illustrated: the first collimated light source and second collimated light source comprise separate beams derived from a common single light source and/or collimating systems.

Herein, for brevity the arrangement of the first collimated light source 16 is generally described and is similar to the first example. It will be understood that the same description therefore applies for the second collimated light source 60, since it is symmetrically arranged about a central longitudinal axis of the device.

As best seen in FIG. 5, the light source 18 projects the light beam 22 with a substantial component in the longitudinal direction 100 to the off-axis parabolic reflector 32 and obliquely over the plane of the output aperture 8. The light source 18 also projects with a component in the opposed lateral direction 104 and the depth direction 104.

As best seen in FIG. 5, the off-axis parabolic reflector 32 is inclined to the longitudinal direction 100 such that a longitudinal component of the light beam 22 incident on the off-axis parabolic reflector 32 is subsequently reflected in an opposed longitudinal direction as the collimated light beam 24. The off-axis parabolic reflector 32 is also inclined to the lateral 102 direction and the depth direction 104, so that the collimated light beam 24 experiences a change in said directions.

Consequently, the off-axis parabolic reflector 32 of the collimating system 20 is arranged to project the collimated light beam 24 substantially obliquely (e.g., not aligned and inclined to the longitudinal direction 100 or lateral direction 102) across the plane of the output aperture 8 in an at least partially overlapping manner.

The off-axis parabolic reflector 32 is arranged to partially overlap the output aperture 8 due to said incline. In variant embodiments, which are not illustrated, the off-axis parabolic reflector is arranged to not to overlap the output aperture, e.g., it may be set back from the output aperture in the lateral direction.

The collimated light generation system 4 includes a mixing element, which in the example is the first prism sheet 38. The first prism sheet 38 is arranged aligned to the lateral direction 102 and has an incline angle of B to the lateral plane and about the lateral axis 102.

Unlike the first example the reflector system 44 is omitted and the first prism sheet 38 projects directly to the second prism sheet 52 (as discussed for the fourth example).

The first prism sheet 38 is symmetrically arranged about a central longitudinal axis and comprises individually symmetric prismatic members. In this manner, the prisms receive the collimated light beam 24 from the first collimated light source 16 and the second collimated light beam 62 from the second collimated light source 60 from either of the associated directions and project the superimposed collimated light beam 64. The central axis 108, 110 of the collimated light beams 24, 62 may be visualised as intersecting at a common intersection point on the first prism sheet 38 (which is at the centre thereof) from which the superimposed collimated light beam 64 projects.

The light source 18, at least part of the off-axis parabolic reflector 32, and the first prism sheet 38 are positioned not to overlap the output aperture 8, when viewed in a plane defined by the lateral and longitudinal directions, as shown in FIG. 5. This reduces their visibility from the output aperture 8. More partially, the light source 18 is arranged generally with the same position in the depth direction 104 to the output aperture 8 to reduce/eliminate its visibility through the output aperture 8.

In embodiments that comprise the coupling system to couple the light beam 22 to the off-axis parabolic reflector 32, the coupling system (e.g., a prism or light pipe) is arranged not to overlap the output aperture 8.

The light source 18 and optional coupling system are arranged not to interfere with the light projected from the first prism sheet 38 and/or the off-axis parabolic reflector 32. Unlike the first example, this is achieved by arranging the light source an optional coupling system not to overlap the output aperture. With such arrangements, it may be ensured that the light source and optional coupling system are not visible though the output aperture and do not interfere with the light projected from the collimating system and/or first prism sheet.

### Sixth to Nineth Examples

In a sixth example, which is not illustrated: the first and second collimated light source are alternatively arranged at opposed longitudinal ends of the device, and with the device of the fifth example effectively halved in the lateral direction, such that there are two separate first prism sheets that each receive light from one of the collimated light sources, and the second prism sheet acts as the mixing element with the point of intersection at its centre.

In a seventh example, which is not illustrated: the fifth example is implemented with a single collimated light source and the device is effectively halved in the lateral direction, such that the collimated light source of the fifth example is provided with the functional realisation of the first example.

In an eighth example, which is not illustrated: the fifth or first example may be adapted so that a plurality of the collimated light generation systems are arranged in a row, such that each of said systems provides a separate collimated sunlight component as adjoining rectangles in the lateral direction over a common output aperture. In such an example it will be understood that the light source and collimation system of the collimated light generation system may project from the same longitudinal end of the device, or from both ends, e.g., they may be staggered so that they are sequentially from opposed ends. With such an example, the collimated light beams have longitudinally aligned and laterally and offset central axis.

In a nineth example, which is not illustrated: the fifth example may be adapted so that two collimated light generation systems are arranged on opposed longitudinal ends of the device, such that each of said systems provides a separate collimated sunlight component as adjoining rectangles in the longitudinal direction over the output aperture. With such an example, the collimated light beams have laterally aligned and longitudinally and offset central axis.

### Tenth Example

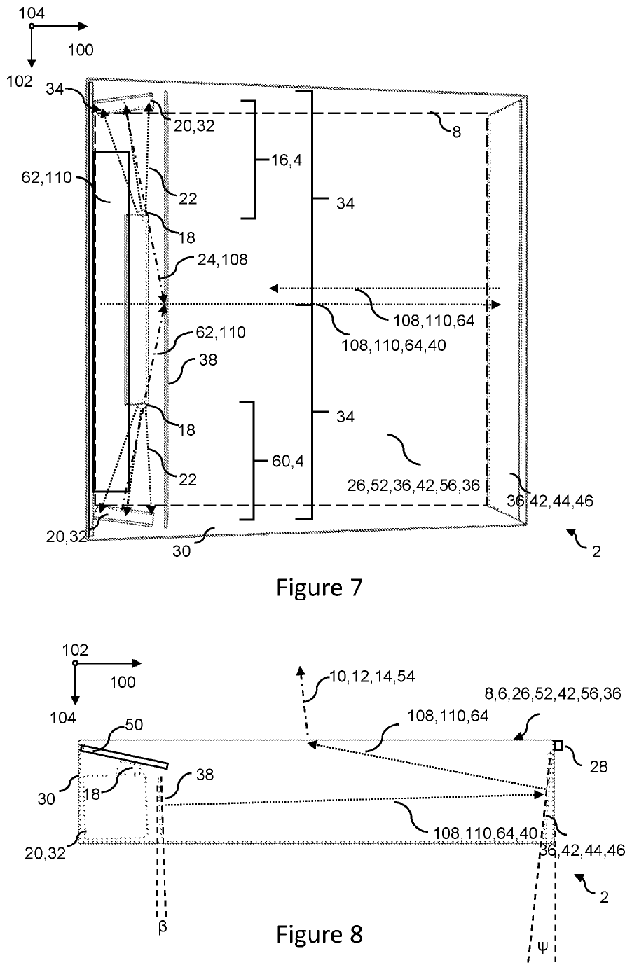

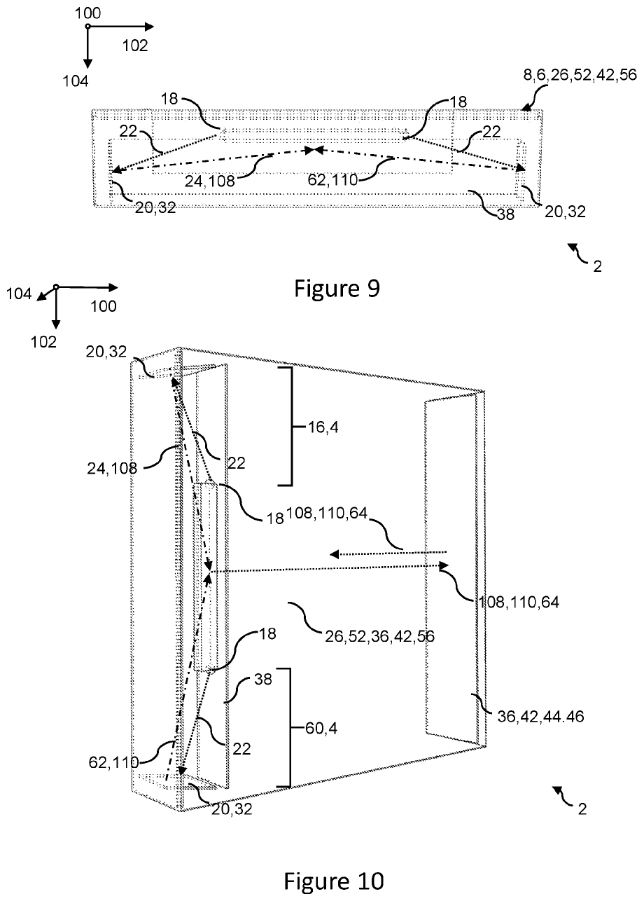

Referring to FIGS. 7 to 10, in a tenth example of the device 2, the fifth example is adapted to include: the first prism 38 sheet is transparent such that collimated light is transmitted therethrough, and; a reflector system 44 similar to the first example is implemented, as will be discussed. The tenth example shares all compatible features and variants in common with the first example, which for brevity are not reiterated.

In the tenth example the collimated light generation system 4 comprises: the first collimated light source 16, and; the second collimated light source 60. The collimated light generation system 4 is arranged with the first collimated light beam 24 and the second collimated light beam 62 both projected through the output aperture 8.

As for the fifth example, the first collimated light beam 24 and the second collimated light beam 62 are superimposed on each other such that they have common central axes 108, 110. A superimposed collimated light beam 64 is projected through the output aperture 8 as the collimated sunlight component 12.

In variant embodiments, which are not illustrated: the collimated light beams are superimposed on each other without alignment of their central axes, e.g., said axis may be longitudinally aligned and laterally offset, or the converse etc; the second collimated light source may be omitted.

The first collimated light source 16 comprises a dedicated light source 18 and a collimating system 20. The second collimated light source 60 comprises a dedicated light source 18 and a collimating system 20.

With two separate light sources, each light beam of the first and second collimated light sources may be independently controllable with electrical circuitry. In a first example, the first and second light beam may be configured to project with a different colour beam (which can be achieved by a chromatic system) such that the collimated sunlight component can be controlled in colour (e.g., in CCT) and/or intensity by controlling an intensity of the light sources. In a second variant, the first and second light beam may be configured to project with the same colour beam (including substantially the same colour) such that the collimated sunlight component can be controlled in intensity by controlling an intensity of either collimated light source, e.g., for a low energy mode one of the collimated light sources may be off.

In variant embodiments, which are not illustrated: the first collimated light source and second collimated light source comprise separate beams derived from a common single light source and/or collimating systems.

Herein, for brevity the arrangement of the first collimated light source 16 is generally described and is similar for the first example. It will be understood that the same description therefore applies for the second collimated light source 60, since it is symmetrically arranged about a central longitudinal axis of the device 2.

As best seen in FIG. 7, the light source 18 projects the light beam 22 with a substantial component in the opposed longitudinal direction 100 to the collimating system 22, which is arranged as an off-axis parabolic reflector 32 and obliquely over the plane of the output aperture 8. The light source 18 also projects with a component in the opposed lateral direction 104 and the depth direction 104.

As best seen in FIGS. 7 and 10, the off-axis parabolic reflector 32 is inclined to the longitudinal direction 100 such that an opposed longitudinal component of the light beam 22 incident on the off-axis parabolic reflector 32 is subsequently reflected in the longitudinal direction 100 as the collimated light beam 24. The off-axis parabolic reflector 32 is arranged to overlap the output aperture due to said incline. The off-axis parabolic reflector 32 is also inclined to the lateral 102 direction and the depth direction 104, so that the collimated light beam 24 experiences a change in said directions.

Consequently, the off-axis parabolic reflector 32 of the collimating system 20 is arranged to project the collimated light beam 24 substantially obliquely (e.g., not aligned to the longitudinal direction 100 or lateral direction 102) across the plane of the output aperture 8 in an overlapping manner.

The collimated light generation system 4 includes a mixing element, which in the example is the first prism sheet 38. As best seen in FIG. 8, the first prism sheet 38 is arranged aligned to the lateral direction 102 and has a minor incline angle of B to the lateral plane and about the lateral axis 102.

The first prism sheet 38 is arranged inclined to the off-axis parabolic reflector 32 and forms part of the first optical expansion system 34, as previously discussed.

The first prism sheet 38 is symmetrically arranged about a central longitudinal axis and comprises individually symmetric prismatic members. In this manner, the prisms receive the collimated light beam 24 from the first collimated light source 16 and the second collimated light beam 62 from the second collimated light source 60 from either of the associated directions and project the superimposed collimated light beam 64. The central axis 108, 110 of the collimated light beams 24, 62 may be visualised as intersecting at a common intersection point on the first prism sheet 38 (which is at the centre thereof) from which the superimposed collimated light beam 64 projects.

Unlike the first example, the reflector system 44 is arranged as a single reflective member 46. The first prism sheet 38 projects to the reflective member 46, which subsequently projects to the second prism sheet 52. The first reflective member 46 (e.g., a mirror) is for specular reflection of the first expanded collimated light beam 40. The first reflective member 46 is arranged substantially on the lateral plane at an opposed end of the device to the first prism sheet 38. As best seen in FIG. 8, the first reflective member 46 is inclined to the lateral plane about the lateral axis 102 by an angle ψ. The angle of inclination may be 5-30 degrees. The first reflective member 44 reflects the first expanded collimated light beam 40 to and forms part of the second optical expansion system 36, as previously discussed.

The light source 18 is positioned to overlap the output aperture 8, when viewed in a plane defined by the lateral and longitudinal directions, as shown in FIG. 7. The light source 18 projects the light beam 22 obliquely over the plane in which the output aperture 8 is arranged, to the off-axis parabolic reflector 32. In embodiments that comprise the coupling system to couple the light beam 22 to the off-axis parabolic reflector 32, the coupling system (e.g., a light pipe as discussed for the first example) is arranged to overlap the output aperture 8.

The light source 18, optional coupling system, and off-axis parabolic reflector 32 and first prism sheet 38 are arranged: not to interfere with the light projected from the first prism sheet 38 and/or the off-axis parabolic reflector 32, and; to be at least partially obscured when viewed from external the output aperture 8 (as was discussed for the first example).

In particular, as best seen in FIG. 8, the shelf member 50 is implemented in combination with the first reflective member 46 to avoid said interference by reflecting the light around these components and by at least partially obscuring their view from external the output aperture 8.

As best seen in FIG. 7, the light source 18 of the first collimated light source 16 projects substantially in the counter lateral direction 102 and the light source 18 of the second collimated light source 60 projects substantially in the lateral direction 102. With such an arrangement the light sources may conveniently be arranged on the same carrier and/or may be arranged not to interfere with each other.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 Device
   4 Collimated light generation system
      16 First collimated light source
         18 Light source
         22 Light beam
         20 Collimating system
         32 Off-axis parabolic reflector
         24 Collimated light beam
         108 Central axis of light beam
      34 First optical expansion system
         38 First prism sheet (Mixing element)
         40 First expanded collimated light beam
      36 Second optical expansion system
         52 Second prism sheet
         54 Second expanded collimated light beam
      60 Second collimated light source
         62 Second collimated light beam
         110 Central axis of light beam
   42 View control system
      44 Reflector system
         46 First reflective member
         48 Second reflective member
         50 Shelf member
      56 Viewing angle dependent member
   6 Diffuse light generation system
      26 Diffuser
      28 Light source
   8 Output aperture
   10 Output light
      12 Collimated sunlight component
      14 Diffuse skylight component
   30 Housing

1. An optical display device arranged to create a perception of a sky scene in output light, the device comprising:
a collimated light generation system comprising: a collimated light source to produce a collimated light beam; a first optical expansion system, and; a second optical expansion system;
a diffuse light generation system, and;
an output aperture through which the output light is projected,
the diffuse light generation system arranged to generate a diffuse skylight component in the output light, and the collimated light generation system arranged to generate a collimated sunlight component in the output light,
wherein the first optical expansion system is arranged to expand the collimated light beam in a first expanded direction over the output aperture as the collimated sunlight component,
and the second optical expansion system is arranged to separately and subsequently expand the collimated light beam in a second expanded direction over the output aperture as the collimated sunlight component,
and the second expanded direction is different to the first expanded direction.

2. The optical display device of claim 1, wherein the first optical expansion system is separate from and upstream of the second optical expansion system and the first optical expansion system does not expand the collimated light beam in the second direction and/or the second optical expansion system does not expand the collimated light beam in the first expanded direction.

3. The optical display device of claim 1, wherein the first and second optical expansion system are arranged for uniform expansion and/or consist of linear expansion of the collimated light in the associated expansion directions.

4. The optical display device of claim 1, wherein an average angle of divergence of the light expanded collimated light beam is within 5% or 10% of an angle of divergence of the collimated light beam.

5. The optical display device of claim 1, wherein the collimated light beam is expanded in both directions by at least 3 or 5 times.

6. The optical display device of claim 1, wherein the collimated light beam is expanded in at least one of said directions to the extent of the output aperture in said direction.

7. The optical display device of claim 1, wherein the first and second expansion direction are orthogonal to each other over the output aperture.

8. The optical display device of claim 7, wherein the output aperture extends in a longitudinal and lateral direction, wherein the first direction is aligned to the lateral direction and the second direction is aligned to the longitudinal direction.

9. The optical display device of claim 1, wherein the first optical expansion system comprises:
a prism sheet arranged inclined to a direction of propagation of the collimated light beam,
and to expand the collimated light beam to a first expanded collimated light beam.

10. The optical display device of claim 9, wherein the prism sheet is arranged for transmission of the collimated light beam therethrough.

11. The optical display device of claim 9, wherein the prism sheet is arranged inclined to the inclined aperture.

12. The optical display device of claim 9, wherein the second optical expansion system comprises:
a second prism sheet arranged inclined to a direction of propagation of the first expanded collimated light beam, and to expand the first collimated light beam to a second expanded collimated light beam.

13. The optical display device of claim 12, wherein the second prism sheet is arranged over the output aperture and to project the second expanded collimated light beam through the output aperture as the collimated sunlight component.

14. The optical display device of claim 13, wherein the second prism sheet is arranged planar to the output aperture.

15. The optical display device of claim 1, wherein the collimated light source comprises a light source and a collimating system to receive light from the light source and produce the collimated light beam therefrom, wherein the collimation system is an off-axis parabolic reflector.

16. The optical display device of claim 15, wherein the collimated light source includes a coupling system to project light from the light source to the collimating system, wherein the coupling system includes one or more of a prism, a light guide, a lens.

17. The optical display device of claim 15, wherein collimated light source is arranged not to interfere with light projected from the collimating system and an the/or the prism sheet.

18. A kit of parts for assembly into the optical display device of claim 1.

19. A method of creating a perception of a sky scene comprising:
expanding light from a collimated light beam in a first direction when viewed at an output aperture;
expanding subsequently said light from the collimated light beam in a different second direction when viewed at the output aperture, and;
outputting the expanded collimated light as a collimated sunlight component.

20. The method of claim 19 comprising:
transmitting light to a diffuse light generation system to generate a skylight component, and;
outputting diffuse light as a skylight component.
